(19) United States
(12) Patent Application Publication
(10) Pub. No.: US 2026/0121285 A1
(43) Pub. Date: Apr. 30, 2026

(54) TERAHERTZ DEVICE

(71) Applicant: ROHM CO., LTD., Kyoto (JP)

(72) Inventor: Yosuke NISHIDA, Kyoto-shi (JP)

(73) Assignee: ROHM CO., LTD., Kyoto (JP)

(21) Appl. No.: 19/430,520

(22) Filed: Dec. 23, 2025

Related U.S. Application Data
(63) Continuation of application No. PCT/JP2024/018983, filed on May 23, 2024.

(30) Foreign Application Priority Data
Jun. 29, 2023 (JP) 2023-106931

(51) Int. Cl. H01Q 1/38; H01Q 9/02; H01Q 9/04

(52) U.S. Cl. CPC H01Q 1/38; H01Q 9/02; H01Q 9/0464

(57) ABSTRACT

A terahertz device includes a substrate having a front surface, a conductive layer formed on the front surface, an annular slot formed in the conductive layer, and first and second active elements disposed in the slot to oscillate or detect electromagnetic waves. The conductive layer includes a first electrode defined by the slot, and a second electrode surrounding the first electrode with the slot located in between. The first active element and the second active element are disposed at opposite sides of the first electrode on a straight reference line that extends through a center of the first electrode as viewed in a plan view taken from a direction orthogonal to the front surface. A first distance between opposite ends of the second electrode on the straight reference line is less than a first substrate distance between opposite ends of the substrate on the straight reference line.

### CROSS-REFERENCE TO RELATED APPLICATIONS

This application is a continuation of, and claims the benefit of priority from International Application No. PCT/JP2024/018983, filed on May 23, 2024, which claims the benefit of priority from Japanese Patent Application No. 2023-106931, filed on June 29, 2023, the entire contents of each are incorporated herein by reference.

### BACKGROUND

### 1. Field

The present disclosure relates to a terahertz device.

### 2. Description of Related Art

The trend toward miniaturization of electronic devices such as transistors has led to nano-scale devices that exhibit quantum effects. Ultrahigh-speed devices and novel functional devices that utilize quantum effects are currently under development.

In such an environment, there is ongoing research aimed at utilizing electromagnetic waves in the frequency range referred to as the terahertz band, which covers frequencies from 0.1 THz to 10 THz, for large-capacity communication, information processing, imaging, and measurement. This frequency range exhibits characteristics of both light and radio waves. Therefore, if devices capable of operating in this frequency band can be developed, they may be applied to a wide variety of fields, including physical property analysis, astronomy, and biology, in addition to imaging, large-capacity communication, and information processing.

A known example of an element that emits or receives electromagnetic waves having a frequency in the terahertz band is a terahertz device constructed by integrating a resonant tunneling diode and a micro-antenna (refer to, for example, JP2020-115500A).

### BRIEF DESCRIPTION OF DRAWINGS

FIG. 1 is a schematic plan view of an exemplary terahertz device in accordance with a first embodiment.

FIG. 2 is a schematic perspective view of the terahertz device illustrated in FIG. 1.

FIG. 3 is a schematic cross-sectional view taken along line F3-F3 in FIG. 1.

FIG. 4 is a schematic plan view showing part of the terahertz device of FIG. 1.

FIG. 5 is a schematic plan view of an active element in the terahertz device of FIG. 1.

FIG. 6 is a schematic plan view of an active element in the terahertz device of FIG. 1.

FIG. 7 is a schematic cross-sectional view of the active elements illustrated in FIGS. 5 and 6.

FIG. 8 is a schematic plan view of a resistive element illustrated in FIG. 1.

FIG. 9 is a schematic cross-sectional view of the resistive element illustrated in FIG. 8.

FIG. 10 is a graph illustrating the conductance of the terahertz device illustrated in FIG. 1.

FIG. 11 is a graph illustrating the conductance of the terahertz device illustrated in FIG. 1.

FIG. 12 is a graph illustrating the conductance of the terahertz device illustrated in FIG. 1.

FIG. 13 is a schematic plan view illustrating a modified example of the terahertz device.

FIG. 14 is a schematic plan view illustrating a modified example of the terahertz device.

FIG. 15 is a schematic plan view illustrating a modified example of the terahertz device.

FIG. 16 is a schematic plan view illustrating a modified example of the terahertz device.

FIG. 17 is a schematic plan view illustrating a modified example of the terahertz device.

FIG. 18 is a schematic plan view illustrating a modified example of the terahertz device.

FIG. 19 is a schematic plan view illustrating a modified example of the terahertz device.

FIG. 20 is a schematic plan view illustrating a modified example of the terahertz device.

FIG. 21 is a schematic plan view of an exemplary terahertz device in accordance with a second embodiment.

FIG. 22 is a schematic plan view of an active element in the terahertz device of FIG. 21.

FIG. 23 is a schematic plan view of an active element in the terahertz device of FIG. 21.

FIG. 24 is a schematic cross-sectional view of the active element illustrated in FIG. 22.

### DETAILED DESCRIPTION

Several embodiments of a terahertz device in accordance with the present disclosure will now be described with reference to the accompanying drawings. Elements in the figures are illustrated for simplicity and clarity and have not necessarily been drawn to scale. To aid understanding, hatching lines may not be shown in the cross-sectional drawings. The accompanying drawings illustrate exemplary embodiments in accordance with the present disclosure and are not intended to limit the present disclosure. Terms such as “first,” “second,” and “third” in this disclosure are used to distinguish subjects and not used for ordinal purposes. In this specification, “equal” will not only cover a state in which the compared subjects are exactly equal but also cover a state in which there is a slight difference, resulting from dimensional tolerances or the like, between the compared subjects.

The detailed description hereafter provides a comprehensive understanding of exemplary methods, apparatuses, and/or systems in accordance with the present disclosure. This detailed description is illustrative and is not intended to limit embodiments of the present disclosure or the application and use of the embodiments.

In this specification, the phrase “at least one of” as used in this disclosure means “one or more” of a desired choice. As one example, the phrase “at least one of” as used in this disclosure includes “only one of the two choices” and “both of the two choices” in a case where the number of choices is two. In another example, the phrase “at least one of” as used in this disclosure includes “only one single choice” and “any combination of two or more choices” if the number of its choices is three or more.

A terahertz device is used as a light source that emits electromagnetic waves having a frequency in the terahertz band or as a detector that detects electromagnetic waves having a frequency in the terahertz band. It is desirable for such a terahertz device to have higher output and improved resolution. Thus, it is preferable that the antenna impedance be adjustable.

### First Embodiment

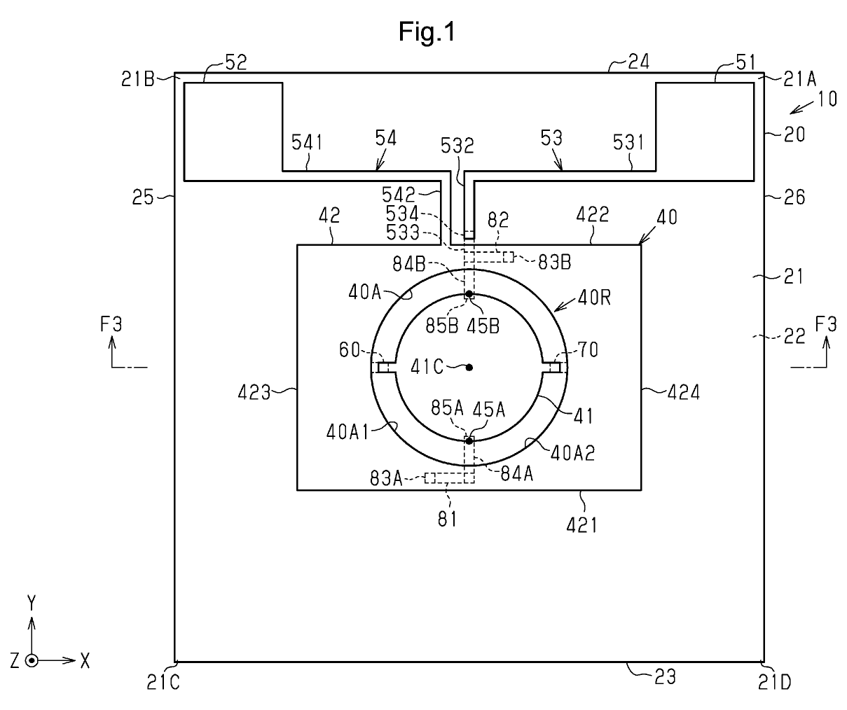

With reference to FIGS. 1 to 12, a terahertz device 10 in accordance with the first embodiment will now be described.

### Schematic Configuration of Terahertz Device

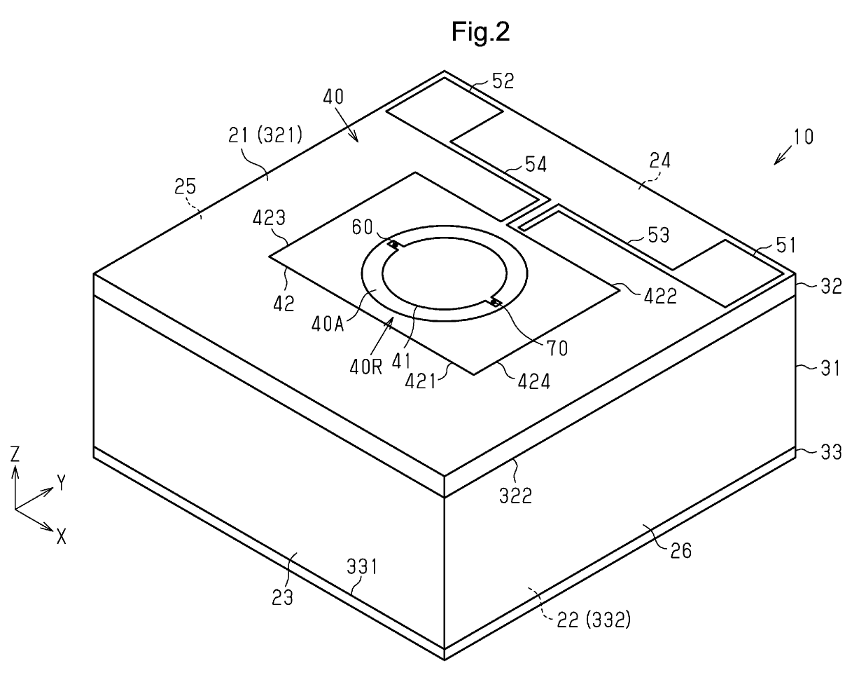

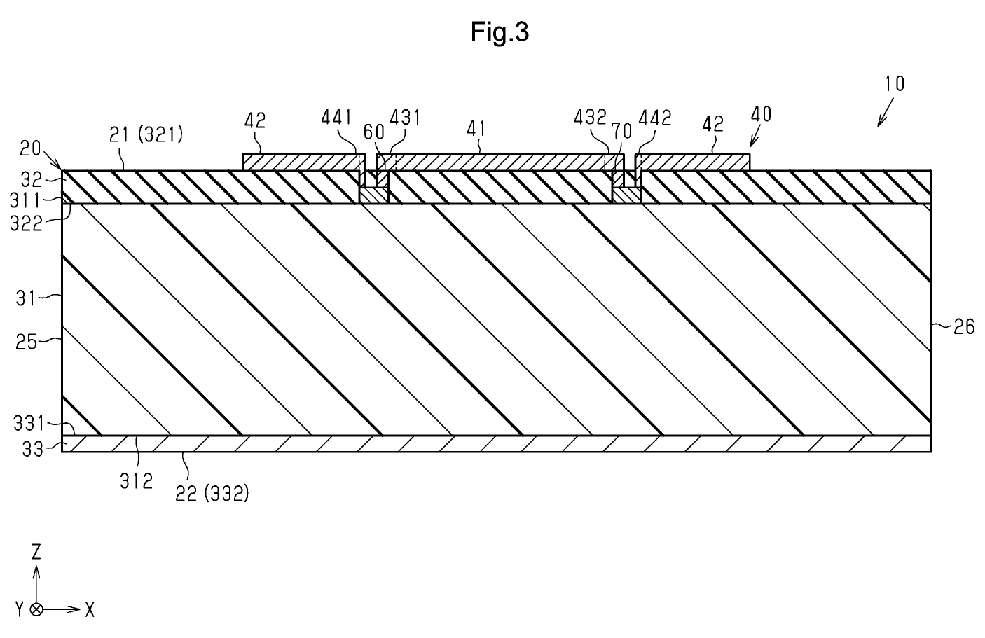

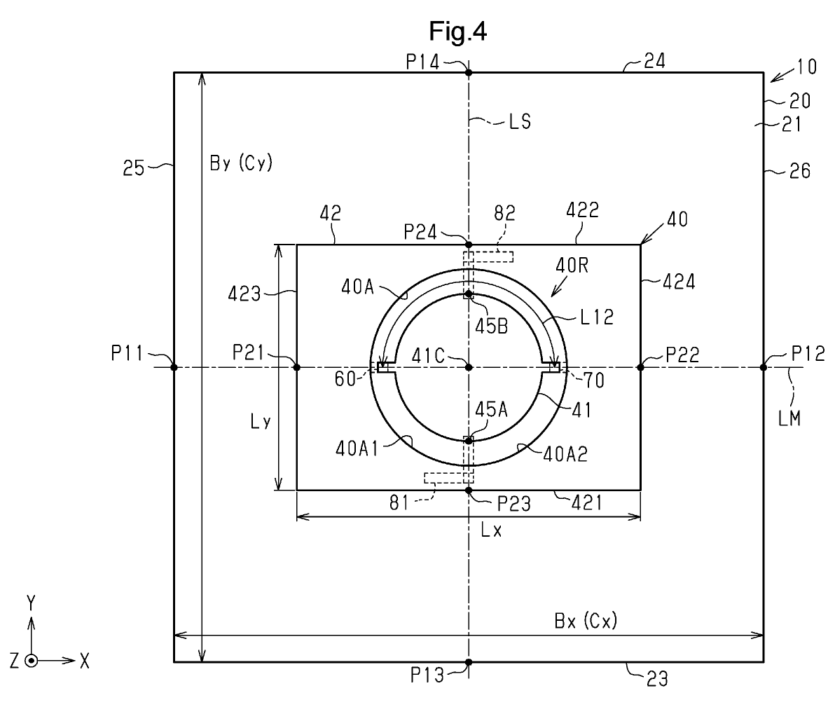

FIG. 1 is a schematic plan view of an exemplary terahertz device 10 in accordance with the first embodiment. FIG. 2 is a schematic perspective view of the terahertz device 10 illustrated in FIG. 1. FIG. 3 is a schematic cross-sectional view taken along line F3-F3 in FIG. 1. FIG. 4 is a schematic plan view of part of the terahertz device 10 illustrated in FIG. 1 and shows the arrangement of a first electrode 41, a second electrode 42, a first active element 60, a second active element 70, a first resistive element 81, and a second resistive element 82. In the present disclosure, the X-axis, Y-axis, and Z-axis are orthogonal to one another as shown in FIG. 1. The term “plan view” as used in this specification is a view of the terahertz device 10 taken in the Z-axis direction.

As shown in FIGS. 1 to 4, the terahertz device 10 includes a substrate 20. The substrate 20 has the form of a flat plate. As shown in FIG. 1, the substrate 20 has the form of a rectangular parallelepiped. The substrate 20 includes a front surface 21, a back surface 22, and side surfaces 23, 24, 25, and 26. The front surface 21 of the substrate 20 and the back surface 22 of the substrate 20 are located at opposite sides in the Z-axis direction. Thus, the plan view is taken in a direction orthogonal to the front surface 21 of the substrate 20. In this specification, “orthogonal” is not meant to be strictly orthogonal and includes a generally orthogonal state allowing the advantages of the present embodiment to be obtained. The side surfaces 23 to 26 of the substrate 20 are each oriented in the X-axis direction or the Y-axis direction. The side surface 23 and the side surface 24 extend along XZ planes. The side surface 23 and the side surface 24 are located at opposite sides in the Y-axis direction. The side surface 25 and the side surface 26 extend along YZ planes. The side surface 25 and the side surface 26 are located at opposite sides in the X-axis direction.

The substrate 20 includes a length Bx in the X-axis direction and a length By in the Y-axis direction. The length Bx in the X-axis direction is less than or equal to 1 mm. In one example, the length Bx in the X-axis direction is 500 μm. The length By in the Y-axis direction is less than or equal to 1 mm. In one example, the length By in the Y-axis direction is 500 μm.

As shown in FIGS. 2 and 3, the substrate 20 includes a semiconductor substrate 31 and an insulation layer 32 on the semiconductor substrate 31.

The semiconductor substrate 31 has the form of a flat plate. As shown in FIG. 1, the semiconductor substrate 31 is rectangular in plan view. In one example, the semiconductor substrate 31 is square in plan view. The shape of the semiconductor substrate 31 in plan view does not have to be rectangular and may be circular, elliptic, or polygonal.

The semiconductor substrate 31 is formed from at least one semiconductor material selected from a group consisting of indium phosphorus (InP), gallium arsenide (GaAs), aluminum gallium arsenide (AlGaAs), indium gallium arsenide (InGaAs), indium gallium arsenide phosphide (InGaAsP), silicon (Si), silicon carbide (SiC), gallium nitride (GaN), and single-crystal aluminum nitride (AlN). In one example, the semiconductor substrate 31 is formed from a material including InP.

The semiconductor substrate 31 includes a substrate front surface 311 and a substrate back surface 312. The substrate front surface 311 and the substrate back surface 312 face opposite directions. The substrate front surface 311 faces the same direction as the front surface 21, and the substrate back surface 312 faces the same direction as the back surface 22. The semiconductor substrate 31 includes substrate side surfaces forming parts of the side surfaces 23 to 26. The substrate front surface 311 faces the same direction as the front surface 21. Thus, the Z-axis direction is orthogonal to the substrate front surface 311.

The terahertz device 10 includes the insulation layer 32 arranged on the semiconductor substrate 31. The substrate front surface 311 of the semiconductor substrate 31 is covered by the insulation layer 32. The insulation layer 32 is formed from an insulating material. The insulation layer 32 may be formed from a material including, for example, silicon oxide (SiO₂). In one example, the insulation layer 32 is formed over the entire substrate front surface 311 of the semiconductor substrate 31.

The insulation layer 32 includes an insulation front surface 321 and an insulation back surface 322 at the opposite side of the insulation front surface 321. The insulation front surface 321 faces the same direction as the substrate front surface 311, and the insulation back surface 322 faces the same direction as the substrate back surface 312. The insulation front surface 321 forms the front surface 21. The insulation back surface 322 is in contact with the substrate front surface 311 of the semiconductor substrate 31. A further member such as an insulation layer may be arranged between the substrate front surface 311 of the semiconductor substrate 31 and the insulation layer 32. The insulation layer 32 includes insulation side surfaces forming parts of the side surfaces 23 to 26.

The terahertz device 10 includes a conductive layer 40 formed in the front surface 21 of the substrate 20. The conductive layer 40 is formed on parts of the front surface 21 of the substrate 20. The conductive layer 40 is formed from at least one metal material selected from a group consisting of gold (Au), silver (Ag), aluminum (Al), copper (Cu), titanium (Ti), titanium nitride (TiN), and platinum (Pt). The conductive layer 40 includes at least one of Au, Ag, Al, Cu, Ti, and Pt. In one example, the conductive layer 40 is formed from a material including Au. The conductive layer 40 is formed through, for example, sputtering. The conductive layer 40 may be formed by a stack of metal layers.

The terahertz device 10 includes a slot 40A formed in the conductive layer 40. The slot 40A is annular in plan view. In one example, the slot 40A is ring-shaped in plan view. Accordingly, the terahertz device 10 includes the ring-shaped slot 40A.

The conductive layer 40 includes the first electrode 41, which is defined by the slot 40A, and the second electrode 42, which surrounds the first electrode 41 with the slot 40A located in between. In one example, the first electrode 41 is annular in plan view. In one example, the first electrode 41 is located at the center of the substrate 20 in plan view. In one example, the second electrode 42 is rectangular. The second electrode 42 includes a first side 421 and a second side 422, which extend parallel to each other, and a third side 423 and a fourth side 424, which are orthogonal to the first side 421 and the second side 422 in plan view. In one example, the second electrode 42 is rectangular and is longer at the first side 421 and the second side 422 than at the third side 423 and the fourth side 424. In one example, the second electrode 42 is disposed so that the first side 421 and the second side 422 extend in the X-axis direction in plan view. The second electrode 42 may be square so that the first side 421 and the second side 422 are equal in length to the third side 423 and the fourth side 424. Further, the second electrode 42 may be rectangular so that the third side 423 and the fourth side 424 are longer than the first side 421 and the second side 422.

The terahertz device 10 includes the first active element 60 and the second active element 70 that are disposed in the slot 40A. The first active element 60 and the second active element 70 are located in the slot 40A in plan view. Thus, the first active element 60 and the second active element 70 are located between the first electrode 41 and the second electrode 42.

The first active element 60 and the second active element 70 performs conversion between electromagnetic waves and electrical energy. Electromagnetic waves include either one of or both of light and radio waves. The first active element 60 and the second active element 70 oscillate electromagnetic waves in a predetermined frequency band, for example, the terahertz band (terahertz waves). In this case, the first active element 60 and the second active element 70 may each be referred to as a terahertz element that oscillates terahertz waves. Further, for example, the first active element 60 and the second active element 70 detect electromagnetic waves in a predetermined frequency band, for example, the terahertz band (terahertz waves). In this case, the first active element 60 and the second active element 70 may each be referred to as a terahertz element that receives terahertz waves. In one example, the frequency band of the terahertz waves has a range from 0.1 THz to 10 THz, inclusive.

The first active element 60 and the second active element 70 are supplied with and oscillated by electrical energy to convert the supplied electrical energy into electromagnetic waves. This allows the first active element 60 and the second active element 70 to oscillate electromagnetic waves in a given frequency band. Further, the first active element 60 and the second active element 70 receive electromagnetic waves and converts the electromagnetic waves into electrical energy. This allows the first active element 60 and the second active element 70 to detect electromagnetic waves in a given frequency band.

In one example, the first active element 60 and the second active element 70 may each be a Resonant Tunneling Diode (RTD). The first active element 60 and the second active element 70 may each be a diode, other than an RTD, or a transistor. Examples of other active elements include a tunnel injection transit time (TUNNETT) diode, an Impact Ionization Avalanche Transit Time (IMPATT) diode, a GaAs field effect transistor (FET), a GaN FET, a high electron mobility transistor(HEMT), a Heterojunction Bipolar Transistor (HBT), and a Complementary Metal–Oxide–Semiconductor (CMOS) FET.

The first active element 60 and the second active element 70 may each be rectangular in plan view. The first active element 60 and the second active element 70 do not have to be rectangular in plan view and may be circular, elliptic, or polygonal.

As shown in FIG. 4, the first active element 60 and the second active element 70 are connected between the first electrode 41 and the second electrode 42. The first active element 60 and the second active element 70 are disposed at opposite sides of the first electrode 41 on a straight reference line LM extending through the center 41C of the first electrode 41 in plan view. In the first embodiment, the straight reference line LM extends in the X-axis direction. In the first embodiment, the straight reference line LM is parallel to the first side 421 of the second electrode 42 in plan view. Further, the straight reference line LM is parallel to the side surfaces 23 and 24 of the substrate 20 in plan view. In this specification, “parallel” is not meant to be strictly parallel and includes a generally parallel state allowing the advantages of the present embodiment to be obtained.

The first active element 60 and the second active element 70 are connected to the first electrode 41 and the second electrode 42 to perform oscillation in a state in which their phases are inverted with respect to each other (antiphase). The first active element 60 and the second active element 70 are connected in parallel between the first electrode 41 and the second electrode 42.

As shown in FIGS. 1, 3, and 4, the first active element 60 is connected between the second electrode 42 and the first electrode 41. The conductive layer 40 includes a connecting portion 441 extending from the second electrode 42 toward the first electrode 41. Further, the conductive layer 40 includes a connecting portion 431 extending from the first electrode 41 toward the second electrode 42. The first active element 60 is connected between the second electrode 42 and the first electrode 41 by the connecting portion 441 and the connecting portion 431.

As shown in FIGS. 1, 3, and 4, the second active element 70 is connected between the first electrode 41 and the second electrode 42. The conductive layer 40 includes a connecting portion 432 extending from the first electrode 41 toward the second electrode 42. The conductive layer 40 includes a connecting portion 442 extending from the second electrode 42 toward the first electrode 41. The second active element 70 is connected between the first electrode 41 and the second electrode 42 by the connecting portion 432 and the connecting portion 442.

As shown in FIGS. 1 and 4, the terahertz device 10 includes the first resistive element 81 and the second resistive element 82. The first resistive element 81 and the second resistive element 82 are disposed outside the slot 40A. In one example, the first resistive element 81 and the second resistive element 82 overlap the second electrode 42 in plan view. The first resistive element 81 and the second resistive element 82 are disposed at opposite sides of the first electrode 41. The first resistive element 81 and the second resistive element 82 are arranged in symmetry with respect to the first electrode 41. In the terahertz device 10 in accordance with the first embodiment, the first resistive element 81 and the second resistive element 82 are arranged in point symmetry about the center 41C of the first electrode 41.

The first resistive element 81 and the second resistive element 82 are electrically connected in parallel to the first active element 60 and the second active element 70. The first resistive element 81 and the second resistive element 82 suppress parasitic oscillation. This stabilizes oscillation in the terahertz device 10.

The first resistive element 81 and the second resistive element 82 are electrically connected to the first electrode 41 at imaginary short-circuit points 45A and 45B. The first resistive element 81 and the second resistive element 82 are connected to opposite ends of the first electrode 41 on a straight auxiliary line LS extending through the center 41C of the first electrode 41.

The imaginary short-circuit points 45A and 45B are pseudo-short-circuit points where the terahertz waves generated by the first active element 60 and the second active element 70, which oscillate in inverted phases, have a relatively low electric field strength. The imaginary short-circuit points 45A and 45B may be set within a range in which the electric field strength of the terahertz waves is relatively low. The first active element 60 and the second active element 70, which oscillate in inverted phases, generate electric fields that are superimposed with each other. Thus, the electric field strength is relatively low around the middle of the first active element 60 and the second active element 70. This forms spots where the electric field strength is relatively low at locations separated by an equal distance from the first active element 60 and the second active element 70. As shown in FIG. 4, the spots where the electric field strength is relatively low is formed along the straight auxiliary line LS, which extends through the center 41C of the first electrode 41 and which is orthogonal to the straight reference line LM extending through the first active element 60 and the second active element 70.

### Detail of First Active Element and Second Active Element

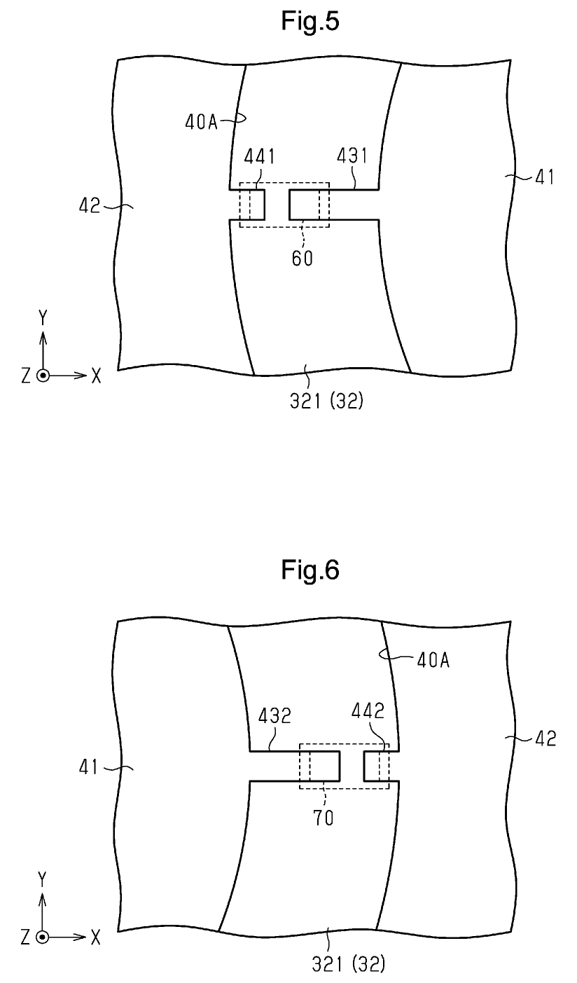

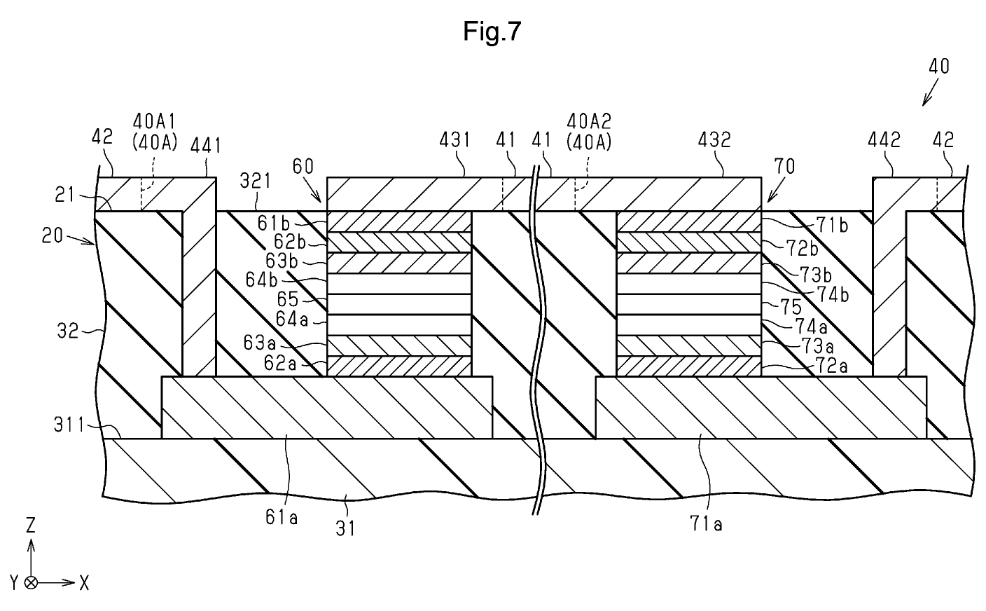

FIG. 5 is a schematic plan view enlarging part of the terahertz device 10 illustrated in FIG. 1 and showing the arrangement of the first active element 60. FIG. 6 is a schematic plan view enlarging part of the terahertz device 10 illustrated in FIG. 1 and showing the arrangement of the second active element 70. FIG. 7 is a schematic cross-sectional view of the first active element 60 and the second active element 70.

One example of the active element 60 will now be described.

As shown in FIGS. 5 and 7, the first active element 60 is located between the second electrode 42 and the semiconductor substrate 31 in the Z-axis direction.

As shown in FIG. 7, a semiconductor layer 61a is arranged on the substrate front surface 311 of the semiconductor substrate 31. In one example, the semiconductor layer 61a is rectangular in plan view. The semiconductor layer 61a is formed from, for example, GaInAs. The semiconductor layer 61a is heavily doped with an n-type impurity. A GaInAs layer 62a is formed on the semiconductor layer 61a. The GaInAs layer 62a is doped with an n-type impurity. The GaInAs layer 62a has a lower n-type impurity concentration than the semiconductor layer 61a. A GaInAs layer 63a is formed on the GaInAs layer 62a. The GaInAs layer 63a is not doped with an impurity.

An AlAs layer 64a is formed on the GaInAs layer 63a. An InGaAs layer 65 is formed on the AlAs layer 64a. The InGaAs layer 65 is not doped with an impurity. An AlAs layer 64b is formed on the InGaAs layer 65. The AlAs layer 64a, the InGaAs layer 65, and the AlAs layer 64b form a resonant tunneling portion.

A GaInAs layer 63b that is not doped with an impurity is formed on the AlAs layer 64b. A GaInAs layer 62b that is doped with an n-type impurity is formed on the GaInAs layer 63b. A GaInAs layer 61b that is doped with n-type impurity at a high concentration is formed on the GaInAs layer 62b. Thus, the GaInAs layer 61b has a higher n-type impurity concentration than the GaInAs layer 62b.

The specific structure of the first active element 60 may be changed as long as electromagnetic waves can be generated and/or detected. In other words, the first active element 60 may have any structure as long as electromagnetic waves in the terahertz band can be at least oscillated or detected.

The connecting portion 441, which extends from the second electrode 42 toward the semiconductor layer 61a, is electrically connected to the semiconductor layer 61a. The connecting portion 431, which extends from the first electrode 41 and contacts the upper surface of the GaInAs layer 61b, is electrically connected to the GaInAs layer 61b. In this manner, the first active element 60 is connected between the second electrode 42 and the first electrode 41.

One example of the active element 70 will now be described.

As shown in FIGS. 6 and 7, the second active element 70 is located between the first electrode 41 and the semiconductor substrate 31 in the Z-axis direction.

As shown in FIG. 7, a semiconductor layer 71a is arranged on the substrate front surface 311 of the semiconductor substrate 31. In one example, the semiconductor layer 71a is rectangular in plan view. The semiconductor layer 71a is formed from, for example, GaInAs. The semiconductor layer 71a is doped with an n-type impurity at a high concentration. A GaInAs layer 72a is formed on the semiconductor layer 71a. The GaInAs layer 72a is doped with an n-type impurity. The GaInAs layer 72a has a lower n-type impurity concentration than the semiconductor layer 71a. A GaInAs layer 73a is formed on the GaInAs layer 72a. The GaInAs layer 73a is not doped with an impurity.

An AlAs layer 74a is formed on the GaInAs layer 73a. An InGaAs layer 75 is formed on the AlAs layer 74a. The InGaAs layer 75 is not doped with an impurity. An AlAs layer 74b is formed on the InGaAs layer 75. The AlAs layer 74a, the InGaAs layer 75, and the AlAs layer 74b form a resonant tunneling structure.

A GaInAs layer 73b that is not doped with an impurity is formed on the AlAs layer 74b. A GaInAs layer 72b that is not doped with an n-type impurity is formed on the GaInAs layer 73b. A GaInAs layer 71b that is doped with n-type impurity at a high concentration is formed on the GaInAs layer 72b. Thus, the GaInAs layer 71b has a higher n-type impurity concentration than the GaInAs layer 72b.

The specific structure of the second active element 70 may be changed as long as electromagnetic waves can be generated and/or detected. In other words, the second active element 70 may have any structure as long as electromagnetic waves in the terahertz band can be at least oscillated or detected.

The connecting portion 432, which extends from the first electrode 41 and contacts the GaInAs layer 71b, is electrically connected to the GaInAs layer 71b. The connecting portion 442, which extends from the second electrode 42 toward the semiconductor layer 71a, is electrically connected to the semiconductor layer 71a. In this manner, the second active element 70 is connected between the first electrode 41 and the second electrode 42.

### Detail of Resistive Elements

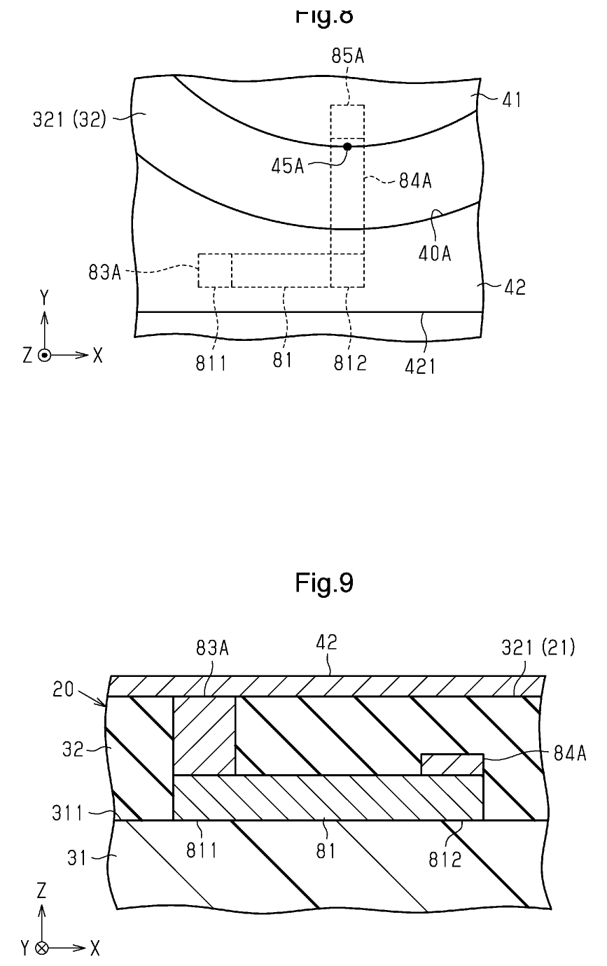

FIG. 8 is a schematic plan view enlarging part of the terahertz device 10 illustrated in FIG. 1 and showing the arrangement of the first resistive element 81. FIG. 9 is a schematic cross-sectional view of the first resistive element 81 illustrated in FIG. 8.

As shown in FIG. 9, the first resistive element 81 is located between the semiconductor substrate 31 and the second electrode 42. The first resistive element 81 is arranged on the substrate front surface 311 of the semiconductor substrate 31. In one example, the first resistive element 81 is rectangular in plan view. The first resistive element 81 is formed by a semiconductor layer doped with an n-type impurity at a high concentration. One example of the semiconductor layer is a GaInAs layer.

The first resistive element 81 includes a first end 811 and a second end 812, opposite to the first end 811. The first end 811 is electrically connected to the second electrode 42 by a via 83A formed on the first resistive element 81. The via 83A is formed from at least one metal material selected from a group consisting of Au, Ag, Al, Cu, Ti, TiN, and Pt. The via 83A includes at least one of Au, Ag, Al, Cu, Ti, and Pt. In one example, the via 83A is formed from a material including Au.

The second end 812 of the first resistive element 81 is electrically connected to a lower wire 84A. The lower wire 84A is disposed in the insulation layer 32 in the Z-axis direction. The lower wire 84A is located between the insulation front surface 321 and the insulation back surface 322 in the Z-axis direction. In one example, the insulation layer 32 may include a first insulation film, which is formed on the semiconductor substrate 31, and a second insulation film, which is formed on the first insulation film. The first insulation film may have, for example, the same thickness as the first resistive element 81. The lower wire 84A may be formed on the first insulation film. The insulation layer 32 may include three or more insulation films. The lower wire 84A is formed from at least one metal material selected from a group consisting of Au, Ag, Al, Cu, Ti, TiN, and Pt. The lower wire 84A includes at least one of Au, Ag, Al, Cu, Ti, and Pt. In one example, the lower wire 84A is formed from a material including Au.

As shown in FIGS. 4 and 8, the lower wire 84A extends toward the first electrode 41. The lower wire 84A intersects the slot 40A between the second electrode 42 and the first electrode 41. The lower wire 84A is electrically connected to the first electrode 41 by a via 85A. As shown in FIG. 4, the via 85A, which electrically connects the lower wire 84A and the first electrode 41, is located at the imaginary short-circuit point 45A. The via 85A is formed from at least one metal material selected from a group consisting of Au, Ag, Al, Cu, Ti, TiN, and Pt. The via 85A includes at least one of Au, Ag, Al, Cu, Ti, and Pt. In one example, the via 85A is formed from a material including Au.

As shown in FIGS. 1 and 4, the second resistive element 82 is electrically connected to the first electrode 41 and the second electrode 42 in the same manner as the first resistive element 81. Although not shown in the drawings, the second resistive element 82 is arranged on the substrate front surface 311 of the semiconductor substrate 31. In one example, the second resistive element 82 is rectangular in plan view. The second resistive element 82 is formed by a semiconductor layer doped with an n-type impurity at a high concentration. One example of the semiconductor layer is a GaInAs layer.

The second resistive element 82 includes a first end 821 and a second end 822, opposite to the first end 821. The first end 821 is electrically connected to the second electrode 42 by a via 83B formed on the second resistive element 82. The via 83B is formed from at least one metal material selected from a group consisting of Au, Ag, Al, Cu, Ti, TiN, and Pt. The via 83B includes at least one of Au, Ag, Al, Cu, Ti, and Pt. In one example, the via 83B is formed from a material including Au.

The second end 822 of the second resistive element 82 is electrically connected to a lower wire 84B. The lower wire 84B is disposed in the insulation layer 32 in the Z-axis direction. The lower wire 84B is located between the insulation front surface 321 and the insulation back surface 322 in the Z-axis direction. In one example, the insulation layer 32 may include a first insulation film, which is formed on the semiconductor substrate 31, and a second insulation film, which is formed on the first insulation film. The first insulation film may have, for example, the same thickness as the second resistive element 82. The lower wire 84B may be formed on the first insulation film. The insulation layer 32 may include three or more insulation films. The lower wire 84B is formed from at least one metal material selected from a group consisting of Au, Ag, Al, Cu, Ti, TiN, and Pt. The lower wire 84B includes at least one of Au, Ag, Al, Cu, Ti, and Pt. In one example, the lower wire 84B is formed from a material including Au.

As shown in FIGS. 4 and 8, the lower wire 84B extends toward the first electrode 41. The lower wire 84B intersects the slot 40A between the second electrode 42 and the first electrode 41 in plan view. The lower wire 84B is electrically connected to the first electrode 41 by a via 85B. As shown in FIG. 4, the via 85B, which electrically connects the lower wire 84B and the first electrode 41, is located at the imaginary short-circuit point 45B. The via 85B is formed from at least one metal material selected from a group consisting of Au, Ag, Al, Cu, Ti, TiN, and Pt. The via 85B includes at least one of Au, Ag, Al, Cu, Ti, and Pt. In one example, the via 85B is formed from a material including Au.

### First Electrode Pads and Second Electrode Pads

As shown in FIGS. 1 and 2, the terahertz device 10 includes a first electrode pad 51 and a second electrode pad 52 arranged on the front surface 21 of the substrate 20. The first electrode pad 51 and the second electrode pad 52 are located at the ends of the substrate 20. In one example, the first electrode pad 51 and the second electrode pad 52 are aligned along the side surface 24 on the front surface 21 of the substrate 20. In the first embodiment, the first electrode pad 51 is located at a corner 21A between the side surface 24 and the side surface 26 in the front surface 21 of the substrate 20. The second electrode pad 52 is located at a corner 21B between the side surface 24 and the side surface 25 in the front surface 21 of the substrate 20.

The terahertz device 10 includes a first interconnection 53 connecting the first electrode pad 51 and the first electrode 41. The first interconnection 53 electrically connects the first electrode pad 51 and the first electrode 41. Preferably, the first interconnection 53 is connected to the first electrode 41 at the imaginary short-circuit point 45B. Connection of the first interconnection 53 to the first electrode 41 at the imaginary short-circuit point 45B suppresses the leakage of electromagnetic waves to the first interconnection 53.

In one example, the first interconnection 53 includes a first wire 531, a second wire 532, a lower wire 533, and a via 534. The first wire 531 extends from the first electrode pad 51 in the X-axis direction. The second wire 532 extends from the distal end of the first wire 531 in the Y-axis direction. The via 534 is connected to the distal end of the second wire 532. The lower wire 533 is connected by the via 534 to the second wire 532 and electrically connected to the lower wire 84B. Thus, the first interconnection 53 electrically connects the first electrode pad 51 and the first electrode 41 with the lower wire 84B and the via 85B. In this manner, the first interconnection 53 connects the first electrode pad 51 to the imaginary short-circuit point 45B of the first electrode 41. The lower wire 533 of the first interconnection 53 may be laid out for connection with the first electrode 41 along a path that differs from the lower wire 84B.

The terahertz device 10 includes a second interconnection 54 connecting the second electrode pad 52 and the second electrode 42. The second interconnection 54 electrically connects the second electrode pad 52 and the second electrode 42. Preferably, the second interconnection 54 is connected to the second electrode 42 at an imaginary short-circuit point. In one example, the second interconnection 54 includes a first wire 541 and a second wire 542. The first wire 541 extends from the second electrode pad 52 in the X-axis direction. The second wire 542 extends from the distal end of the first wire 541 in the Y-axis direction. The second wire 542 extends from the distal end of the first wire 541 toward the second electrode 42 and is electrically connected to the second electrode 42. In the terahertz device 10 in accordance with the first embodiment, the second electrode pad 52 is connected by the second interconnection 54 to the second electrode 42 at the vicinity of the straight auxiliary line LS where an imaginary short-circuit point is formed. Such connection of the second interconnection 54 to the vicinity of the imaginary short-circuit point suppresses the leakage of electromagnetic waves to the second interconnection 54.

### Reflective Layer

The terahertz device 10 includes a reflective layer 33 arranged on the back surface 22 of the substrate 20. The reflective layer 33 is in contact with the back surface 22 of the substrate 20. The reflective layer 33 includes a reflective front surface 331 and a reflective back surface 332 at the opposite side of the reflective front surface 331. The reflective front surface 331 faces the same direction as the substrate front surface 311. The reflective back surface 332 faces the same direction as the substrate back surface 312. The reflective layer 33 has a thickness that allows for the reflection of electromagnetic waves generated or detected by the first active element 60 and the second active element 70.

The reflective layer 33 is formed by a metal layer arranged on the back surface 22 of the substrate 20. The reflective layer 33 is formed from at least one metal material selected from a group consisting of Au, Ag, Al, Cu, Ti, TiN, and Pt. The reflective layer 33 includes at least one of Au, Ag, Al, Cu, Ti, and Pt. In one example, the reflective layer 33 is formed from a material including Au. The reflective layer 33 may be formed from the same material as the conductive layer 40. The reflective layer 33 may be formed through, for example, sputtering. The reflective layer 33 may be formed by a stack of metal layers.

### Operation

The operation of the terahertz device 10 in accordance with the first embodiment will now be described.

The terahertz device 10 includes the substrate 20, the conductive layer 40, the slot 40A, the first active element 60, and the second active element 70. The substrate 20 includes the front surface 21 and the back surface 22, and the conductive layer 40 is formed on parts of the front surface 21. The slot 40A is formed in the conductive layer 40. The slot 40A is annular. The first active element 60 and the second active element 70 are disposed in the slot 40A. The conductive layer 40 includes the first electrode 41, which is defined by the slot 40A, and the second electrode 42, which surrounds the first electrode 41 with the slot 40A located in between. The wall surfaces of the conductive layer 40 (first electrode 41, second electrode 42) defining the annular slot 40A, forms a ring slot antenna 40R.

As shown in FIG. 4, a distance L12 between the first active element 60 and the second active element 70 in the circumferential direction of the slot 40A is equal to one-half of the effective wavelength λg of the terahertz waves generated by the first active element 60 and the second active element 70. In this disclosure, “equal” will not only cover a state in which the compared subjects are exactly equal but also cover a state in which there is a slight difference, resulting from dimensional tolerances or the like, between the compared subjects. The effective wavelength λg is the wavelength of the terahertz waves propagated through the terahertz device 10. The size (radius) of the slot 40A is determined in accordance with the distance L12 between the first active element 60 and the second active element 70. In one example, the radius of the slot 40A may be 30 μm.

The first active element 60 and the second active element 70 lie along the straight reference line LM, which extends through the center 41C of the first electrode 41. The terahertz device 10 includes two oscillators formed by two semicircular slots 40A1 and 40A2 and the first active element 60 and the second active element 70, which are respectively disposed in the semicircular slots 40A1 and 40A2. The first electrode 41 and the second electrode 42, which define the semicircular slots 40A1 and 40A2 accommodating the first active element 60 and the second active element 70, form a slot antenna. The polarization direction of the terahertz waves generated by the slot antenna of the terahertz device 10 coincides with the extending direction of the straight reference line LM, which the first active element 60 and the second active element 70 lie along.

The second electrode 42 includes a first end P21 and a second end P22, which are the opposite ends on the straight reference line LM in plan view. In the second electrode 42, the first end P21 and the second end P22 are separated by a first distance Lx. The first distance Lx corresponds to the electrode size of the second electrode 42 in the polarization direction (direction in which the straight reference line LM extends).

The substrate 20 includes a first substrate end P11 and a second substrate end P12, which are the opposite ends on the straight reference line LM, in plan view. In the substrate 20, the first substrate end P11 and the second substrate end P12 are separated by a first substrate distance Cx. The first substrate distance Cx corresponds to the substrate size of the substrate 20 in the polarization direction (direction in which the straight reference line LM extends).

The first distance Lx of the second electrode 42 is less than the first substrate distance Cx of the substrate 20. The terahertz device 10 includes the second electrode 42, of which the first distance Lx (electrode size) is less than the first substrate distance Cx of the substrate 20. This varies the distribution of standing waves in the second electrode 42. The standing wave distribution affects the impedance at where the first active element 60 and the second active element 70 are located. Thus, the impedance can be adjusted by varying the standing wave distribution, that is, by changing the first distance Lx of the second electrode 42.

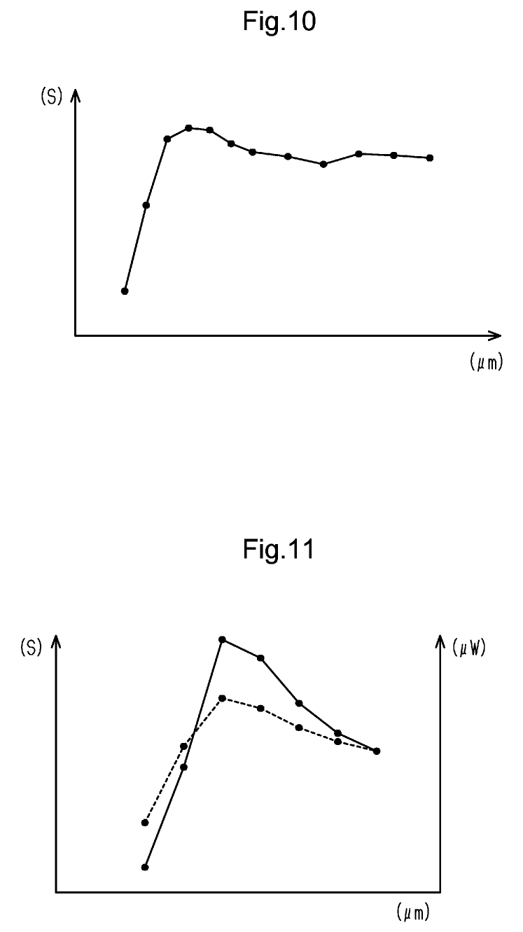

FIG. 10 shows one example of the conductance of the entire terahertz device 10 with respect to the first distance Lx at the resonant frequency. In FIG. 10, the horizontal axis represents the first distance Lx, and the vertical axis represents the conductance (S). FIG. 10 shows the characteristics when the diameter of the slot 40A is 30 μm. Adjustment of the first distance Lx allows for adjustment of the conductance of the entire terahertz device 10. Accordingly, the impedance of the ring slot antenna 40R, which includes the first active element 60, the second active element 70, and the annular slot 40A, can be adjusted.

FIG. 10 shows that the entire conductance decreases greatly when the first distance Lx is small. Preferably, the first distance Lx is less than the effective wavelength λg of the terahertz waves. Preferably, the first distance Lx is less than or equal to one-half of the effective wavelength λg of terahertz waves (λg/2). The first distance Lx may be less than one-half of the effective wavelength λg.

The second electrode 42 includes a third end P23 and a fourth end P24 on the straight auxiliary line LS, which extends through the center 41C of the first electrode 41 and which is orthogonal to the straight reference line LM, in plan view. In the second electrode 42, the third end P23 and the fourth end P24 are separated by a second distance Ly. The second distance Ly corresponds to the electrode size of the second electrode 42 in the direction orthogonal to the polarization direction (i.e., direction in which the straight auxiliary line LS extends). The second distance Ly may be equal to the first distance Lx. Alternatively, the second distance Ly may be less than the first distance Lx or greater than the first distance Lx.

The substrate 20 includes a third substrate end P13 and a fourth substrate end P14, which are the opposite sides on the straight auxiliary line LS, in plan view. In the substrate 20, the third substrate end P13 and the fourth substrate end P14 are separated by a second substrate distance Cy. The second substrate distance Cy corresponds to the substrate size of the substrate 20 in the direction orthogonal to the polarization direction (i.e., direction in which the straight auxiliary line LS extends).

The second distance Ly of the second electrode 42 is less than the second substrate distance Cy of the substrate 20. The terahertz device 10 includes the second electrode 42, of which the second distance Ly (electrode size) is less than the second substrate distance Cy of the substrate 20. This varies the distribution of standing waves in the second electrode 42. The standing wave distribution affects the impedance at where the first active element 60 and the second active element 70 are located. Thus, the impedance can be adjusted by varying the standing wave distribution, that is, by changing the second distance Ly of the second electrode 42.

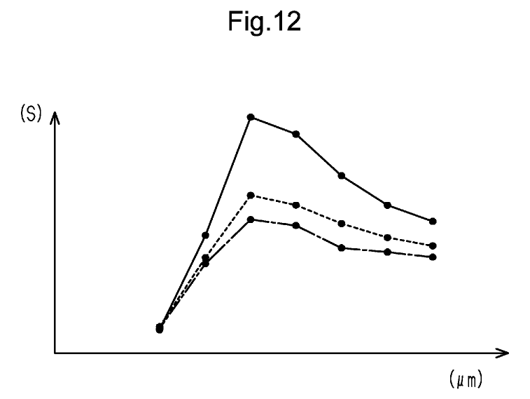

FIG. 12 shows one example of the conductance calculated for the entire terahertz device 10 with respect to the first distance Lx at the resonant frequency when the second distance Ly is changed. In FIG. 12, the horizontal axis represents the first distance Lx, and the vertical axis represents the conductance (S). FIG. 12 shows the characteristics when the diameter of the slot 40A is 30 μm. Further, FIG. 12 shows the conductance for different second distances Ly with the solid line, the broken line, and the single-dashed line. In FIG. 12, the second distance Ly is increased in the order of the solid line, the broken line, and the single-dashed line. In one example, the solid line corresponds to the second distance Ly of 100 μm, the broken line corresponds to the second distance Ly of 150 μm, and the single-dashed line corresponds to the second distance Ly of 200 μm. Adjustment of the second distance Ly allows for adjustment of the conductance of the entire terahertz device 10. Accordingly, the impedance of the ring slot antenna 40R, which includes the first active element 60, the second active element 70, and the annular slot 40A, can be adjusted.

FIG. 11 shows one example of the conductance of the entire terahertz device 10 and the power of the terahertz waves generated by the terahertz device 10 at the resonant frequency when the first distance Lx is changed. In FIG. 11, the horizontal axis represents the first distance Lx, and the vertical axis represents the conductance and the terahertz wave power. FIG. 11 shows the characteristics when the second distance Ly is 100 μm. In FIG. 11, the solid line shows the conductance, and the broken line shows the power. The conductance and the terahertz power can be adjusted by changing the first distance Lx.

The first embodiment has the advantages described below.

(1-1) The terahertz device 10 includes the substrate 20, the conductive layer 40, the slot 40A, the first active element 60, and the second active element 70. The substrate 20 includes the front surface 21 and the back surface 22, and the conductive layer 40 is formed on parts of the front surface 21. The slot 40A is formed in the conductive layer 40. The slot 40A is annular. The first active element 60 and the second active element 70 are disposed in the slot 40A. The conductive layer 40 includes the first electrode 41, which is defined by the slot 40A, and the second electrode 42, which surrounds the first electrode 41 with the slot 40A located in between. The first active element 60 and the second active element 70 are disposed at opposite sides of the first electrode 41 on the straight reference line LM, which extends through the center 41C of the first electrode 41, in plan view. The first distance Lx between the first end P21 and the second end P22 of the second electrode 42 on the straight reference line LM is less than the first substrate distance Cx between the first substrate end P11 and the second substrate end P12 of the substrate 20 on the straight reference line LM.

In the terahertz device 10, the standing wave distribution varies in the second electrode 42. The standing wave distribution affects the impedance at where the first active element 60 and the second active element 70 are located. This allows for impedance adjustment. Adjustment of the impedance increases the output power (electric power) of the terahertz device 10 such that it has higher output.

(1-2) In a plan view, the second distance Ly between the third end P23 and the fourth end P24, which are the opposite ends of the second electrode 42 on the straight auxiliary line LS that extends through the center 41C of the first electrode 41 and is orthogonal to the straight reference line LM, is less than the second substrate distance Cy between the third substrate end P13 and the fourth substrate end P14, which are the opposite ends of the substrate 20 on the straight auxiliary line LS. In the terahertz device 10, the standing wave distribution varies in the second electrode 42. The standing wave distribution affects the impedance at where the first active element 60 and the second active element 70 are located. This allows for impedance adjustment.

(1-3) The first active element 60 and the second active element 70 are connected in parallel. Thus, when the first active element 60 and the second active element 70 oscillate in inverted phases, the output power (electric power) of the terahertz device 10 is increased.

(1-4) The first resistive element 81 and the second resistive element 82 are connected in parallel to the first active element 60 and the second active element 70. This stabilizes oscillation in the terahertz device 10.

(1-5) The terahertz device 10 includes the reflective layer 33 arranged on the substrate back surface 312 of the semiconductor substrate 31. The reflective layer 33 reflects the electromagnetic waves emitted from the ring slot antenna 40R toward the semiconductor substrate 31. This allows the terahertz device 10 to emit electromagnetic waves in the direction toward which the substrate front surface 311 of the substrate 20 is oriented.

(1-6) The first electrode pad 51 and the second electrode pad 52 may be located at the corners 21A and 21B of the substrate 20. This structure reduces the reflected electromagnetic waves blocked by the first electrode pad 51 and the second electrode pad 52 that are directed from the reflective layer 33 toward the front surface 21.

(1-7) The first electrode pad 51 is connected to the first electrode 41 by the first interconnection 53. The first interconnection 53 is connected to the imaginary short-circuit point 45B of the first electrode 41. Connection of the first interconnection 53 to the imaginary short-circuit point 45B suppresses the leakage of electromagnetic waves to the first interconnection 53.

(1-8) The second electrode pad 52 is connected to the second electrode 42 by the second interconnection 54. The second interconnection 54 is connected to the second electrode 42 in the vicinity of the straight auxiliary line LS, which forms the imaginary short-circuit point. Connection of the second interconnection 54 to the second electrode 42 at the vicinity of the imaginary short-circuit point suppresses the leakage of electromagnetic waves to the second interconnection 54.

### Modified Example of First Embodiment

The first embodiment may be modified as described below. The first embodiment and modified examples described below may be combined as long as there is no technical contradiction. In the modified examples described hereafter, same reference characters are given to those components that are the same as the corresponding components of the first embodiment. Such components will not be described in detail.

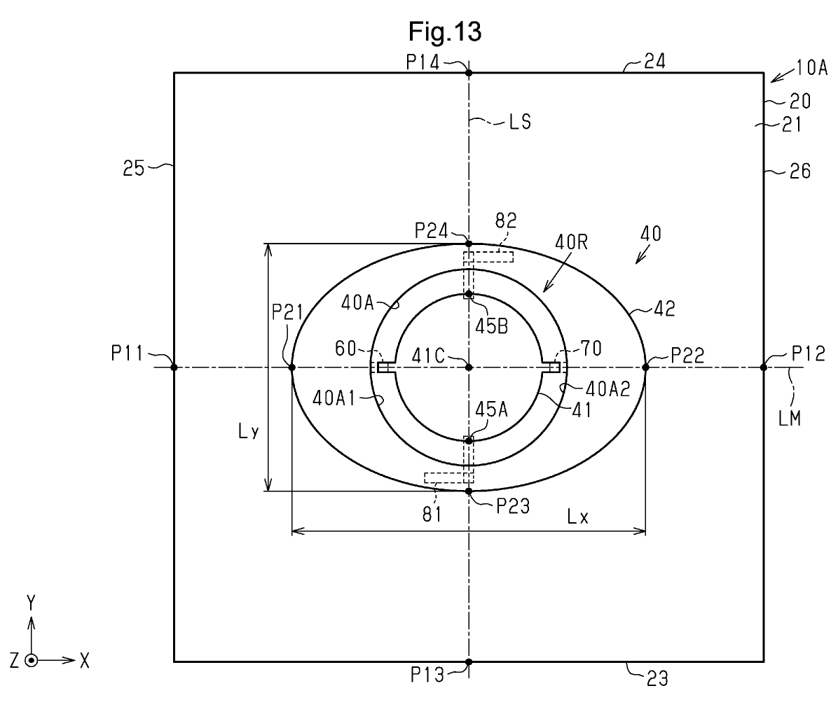

As shown in FIG. 13, a terahertz device 10A of a modified example includes an elliptical second electrode 42. The second electrode 42 includes a first end P21 and a second end P22 on the straight reference line LM. Further, the second electrode 42 includes a third end P23 and a fourth end P24 on the straight auxiliary line LS. The second electrode 42 is elliptical, and the first distance Lx between the first end P21 and the second end P22 is greater than the second distance Ly between the third end P23 and the fourth end P24. In contrast with the second electrode 42 of the first embodiment, the second electrode 42 of the terahertz device 10A does not include corners. Thus, the terahertz device 10A limits the emission of electromagnetic waves from the outer ends of the second electrode 42 and improves the emission pattern of electromagnetic waves.

The second electrode 42 may be circular so that the first distance Lx is equal to the second distance Ly. The second electrode 42 may be elliptical so that the first distance Lx is less than the second distance Ly. Instead of being elliptical, the second electrode 42 may be, for example, polygonal, rhombic, trapezoidal, oval, or have any other shape.

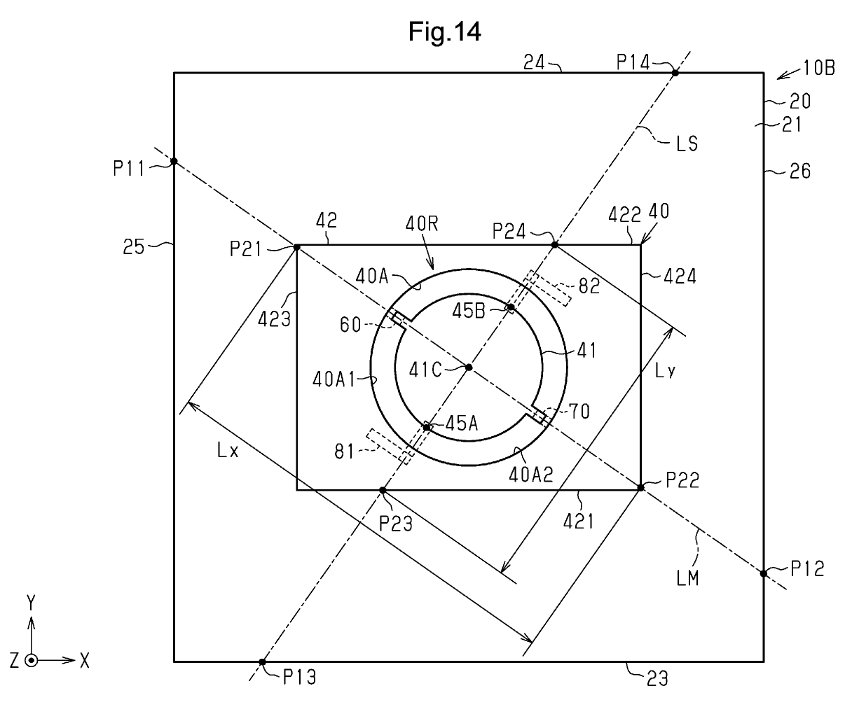

As shown in FIG. 14, a terahertz device 10B of a modified example differs from the first embodiment in the arrangement of the first active element 60 and the second active element 70. In the terahertz device 10B of the modified example, the straight reference line LM, which extends through the center 41C of the first electrode 41, is inclined relative to the first side 421 and the second side 422 of the second electrode 42 in plan view. The first side 421 and the second side 422 of the second electrode 42 are parallel to the side surface 23 and the side surface 24 of the substrate 20. The first active element 60 and the second active element 70 are located on the straight reference line LM at opposite sides of the first electrode 41. The first active element 60 and the second active element 70 are located on the straight reference line LM that is rotated about the center 41C of the first electrode 41 relative to the X-axis direction and the Y-axis direction.

The terahertz device 10B of this modified example adjusts the first distance Lx and the second distance Ly by changing the rotation angle of the first active element 60 and the second active element 70, that is, the angle of the straight reference line LM relative to the first side 421 and the second side 422 of the second electrode 42. In this manner, the terahertz device 10B of the modified example allows for adjustment of the impedance, without changing the size of the second electrode 42, by inclining the straight reference line LM, which indicates the polarization direction set by the first active element 60 and the second active element 70.

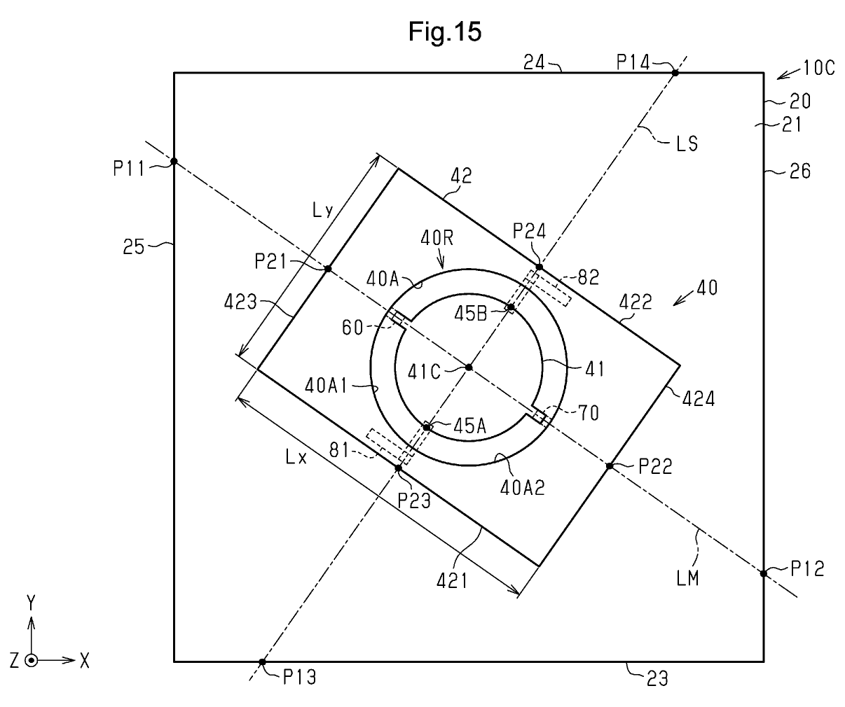

As shown in FIG. 15, a terahertz device 10C of a modified example includes a rectangular second electrode 42. The first side 421 and the second side 422 of the second electrode 42 are inclined relative to the side surface 23 and the side surface 24 of the substrate 20. The straight reference line LM is parallel to the first side 421 of the second electrode 42. In this manner, the second electrode 42 may be inclined relative to the substrate 20 in plan view. In the terahertz device 10C of this example, the angle of the second electrode 42, that is, the angle of the straight reference line LM, allows the first substrate distance Cx between the first substrate end P11 and the second substrate end P12, which are the opposite ends of the substrate 20, to be changed.

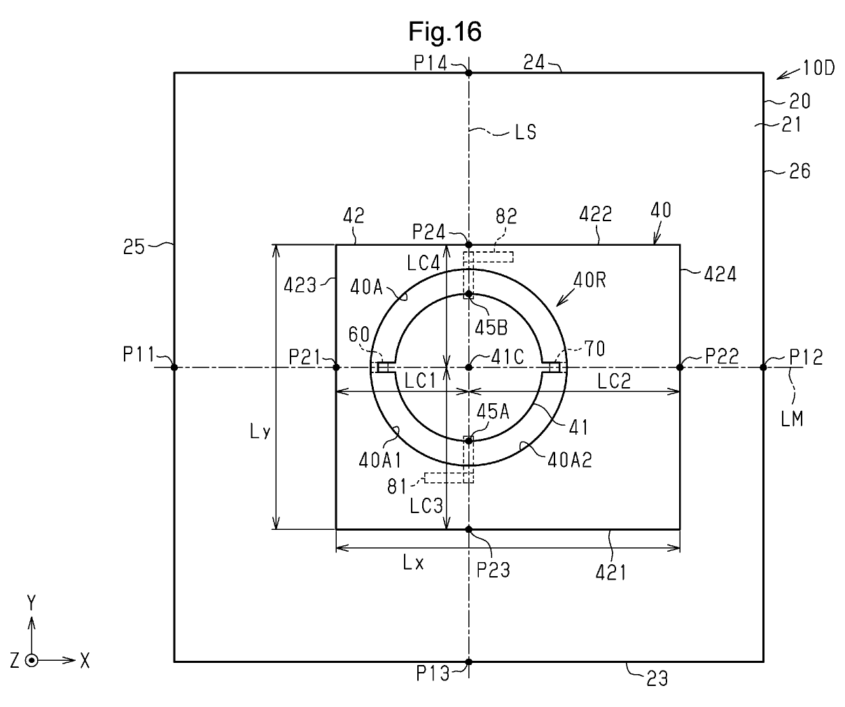

As shown in FIG. 16, a terahertz device 10D of a modified example includes a rectangular second electrode 42. The first side 421 and the second side 422 of the second electrode 42 are parallel to the side surface 23 and the side surface 24 of the substrate 20. The second electrode 42 is located toward the side surfaces 23 and 26 of the substrate 20. The second electrode 42 includes the first end P21 and the second end P22 on the straight reference line LM. The distance LC1 from the center 41C of the first electrode 41 to the first end P21 is less than the distance LC2 from the center 41C of the first electrode 41 to the second end P22. The second electrode 42 includes the third end P23 and the fourth end P24 on the straight auxiliary line LS. The distance LC3 from the center 41C of the first electrode 41 to the third end P23 is greater than the distance LC4 from the center 41C of the first electrode 41 to the fourth end P24. The second electrode 42 is arranged in an asymmetric manner with respect to the center 41C of the first electrode 41. In the terahertz device 10D of this modified example, the admittance is asymmetric at the first active element 60 and the second active element 70. The terahertz device 10D of this modified example allows impedance matching to be performed for each of the active elements that have different mesa sizes.

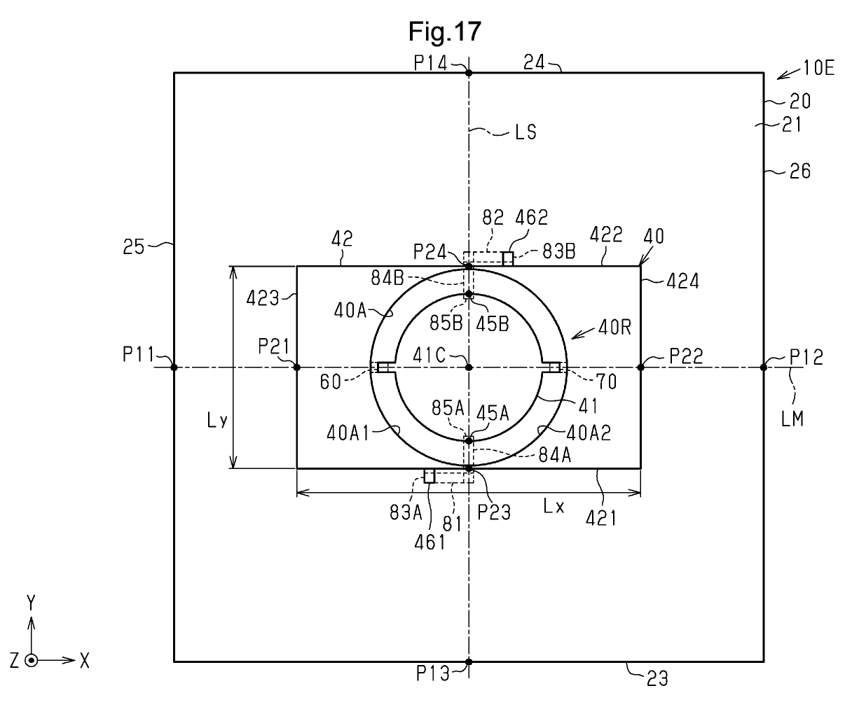

As shown in FIG. 17, in a terahertz device 10E of a modified example, the first resistive element 81 and the second resistive element 82 are disposed outside the second electrode 42. The first resistive element 81 extends along the first side 421 of the second electrode 42, and the second resistive element 82 extends along the second side 422 of the second electrode 42. The first resistive element 81 and the second resistive element 82 are separated from the second electrode 42. The second electrode 42 includes resistor connecting portions 461 and 462 projecting from the first side 421 and the second side 422 in the Y-axis direction. The first resistive element 81 and the second resistive element 82 are electrically connected to the second electrode 42 by the vias 83A and 83B and the resistor connecting portions 461 and 462. The terahertz device 10E of this modified example allows the second distance Ly of the second electrode 42 to be decreased by disposing the first resistive element 81 and the second resistive element 82 outside the second electrode 42.

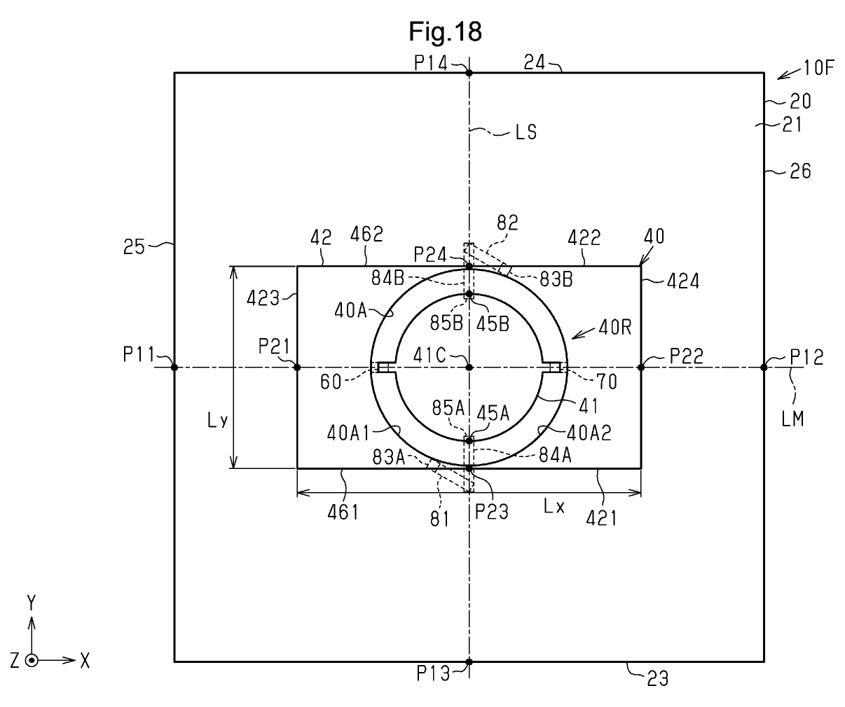

As shown in FIG. 18, in a terahertz device 10F of a modified example, the first resistive element 81 and the second resistive element 82 are inclined relative to the first side 421 and the second side 422 of the second electrode 42. The first resistive element 81 and the second resistive element 82 partially overlap the second electrode 42. Thus, the first resistive element 81 and the second resistive element 82 are partially located outside the second electrode 42. The first resistive element 81 and the second resistive element 82 are electrically connected to the second electrode 42 by the vias 83A and 83B, which overlap the second electrode 42. In the terahertz device 10F of this modified example, the first resistive element 81 and the second resistive element 82 partially overlap the second electrode 42 and allow the second distance Ly of the second electrode 42 to be decreased.

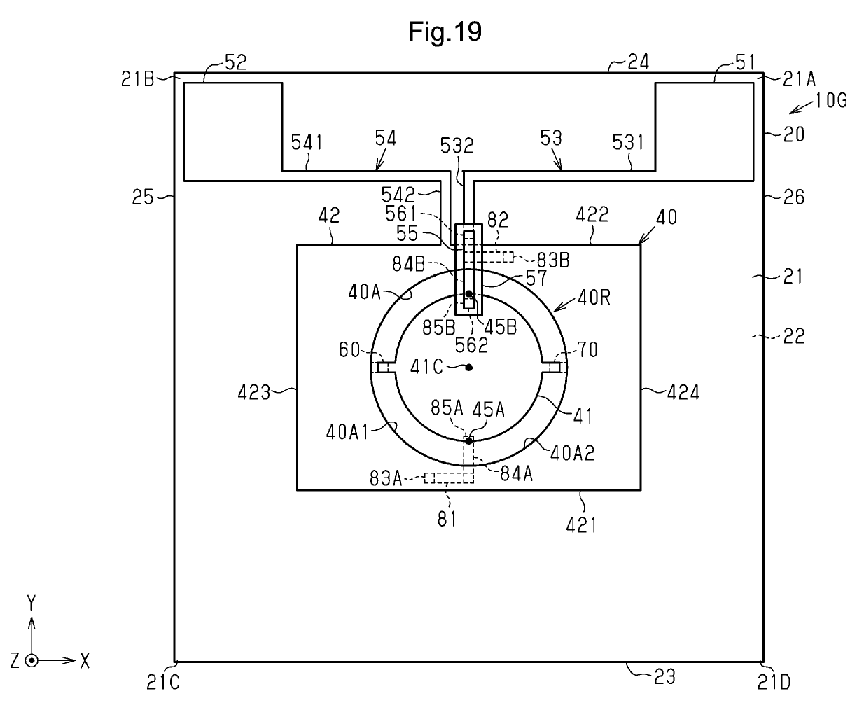

FIG. 19 shows a terahertz device 10G of a modified example including an upper wire 55 that extends across the slot 40A. More specifically, the terahertz device 10G of this modified example includes the first interconnection 53 that electrically connects the first electrode pad 51 and the first electrode 41. The first interconnection 53 includes the first wire 531, the second wire 532, the upper wire 55, and vias 561 and 562. The terahertz device 10G includes an insulation layer 57 formed on the conductive layer 40. The upper wire 55 is formed on the insulation layer 57. The upper wire 55 is electrically connected to the second wire 532 by the via 561, which extends through the insulation layer 57. Further, the upper wire 55 is electrically connected to the first electrode 41 by the via 562, which extends through the insulation layer 57. The via 562 may be located at the imaginary short-circuit point 45B.

In the terahertz device 10E of the modified example shown in FIG. 17, the first resistive element 81 and the second resistive element 82 may be connected to the first electrode 41 by a structure that is the same as the upper wire 55 shown in FIG. 19. Further, in the terahertz device 10F of the modified example shown in FIG. 18, the first resistive element 81 and the second resistive element 82 may be connected to the first electrode 41 by a structure that is the same as the upper wire 55 shown in FIG. 19.

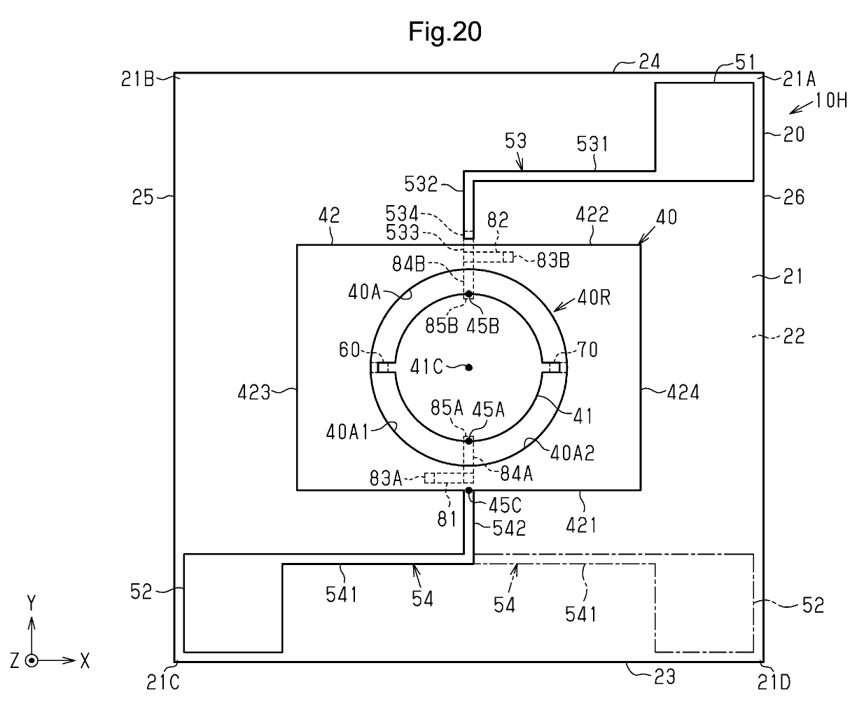

As shown in FIG. 20, in a terahertz device 10H of a modified example, the first electrode pad 51 and the second electrode pad 52 are arranged at diagonally opposing corners. The second electrode pad 52 is located at a corner 21C between the side surface 23 and the side surface 25 in the front surface 21 of the substrate 20.

The second electrode pad 52 is electrically connected to the second electrode 42 at an imaginary short-circuit point 45C of the second electrode 42 that is located at an opposite side of the imaginary short-circuit point 45B of the first electrode 41 where the first electrode pad 51 is connected with respect to the center 41C of the first electrode 41. The second electrode pad 52 is electrically connected to the first side 421 of the second electrode 42 by the second interconnection 54. In this manner, connection of the second interconnection 54 to the second electrode 42 at the imaginary short-circuit point 45C suppresses the leakage of electromagnetic waves to the second interconnection 54. As shown by the broken lines in FIG. 20, the second electrode pad 52 may be located at a corner 21D between the side surface 23 and the side surface 26 in the front surface 21 of the substrate 20.

### Second Embodiment

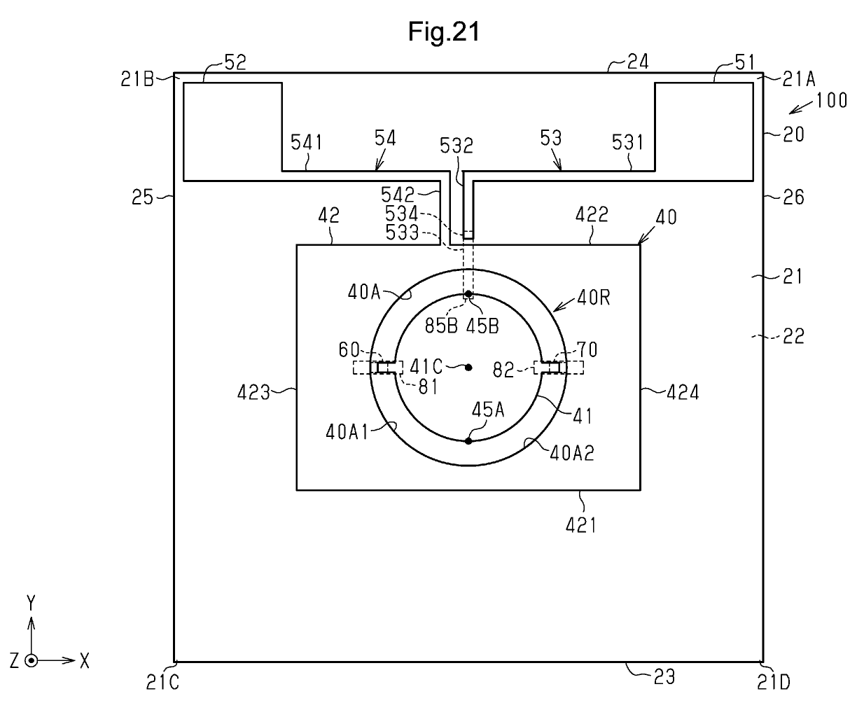

With reference to FIGS. 21 to 24, a terahertz device 100 in accordance with a second embodiment will now be described.

In the second embodiment, same reference numerals are given to those components that are the same as the corresponding components of the first embodiment. Such components will not be described in detail.

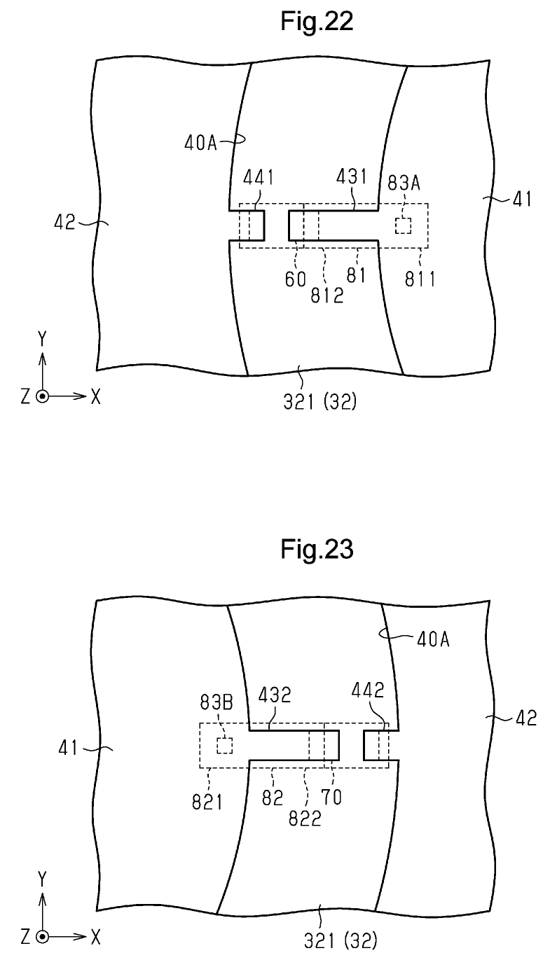

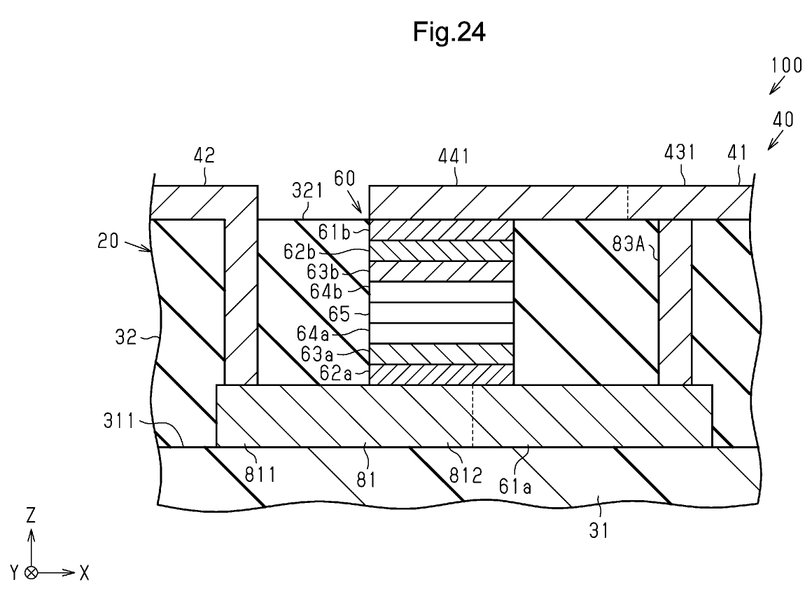

FIG. 21 is a schematic plan view of an exemplary terahertz device 100 in accordance with the second embodiment. FIG. 22 is a schematic plan view of part of the terahertz device 100 illustrated in FIG. 21 and shows the first active element 60 and the first resistive element 81. FIG. 23 is a schematic plan view of part of the terahertz device 100 illustrated in FIG. 21 and shows the second active element 70 and the second resistive element 82. FIG. 24 is a schematic cross-sectional view of the first active element 60 and the first resistive element 81 illustrated in FIG. 21.

As shown in FIG. 21, the terahertz device 100 in accordance with the second embodiment includes the first resistive element 81 and the second resistive element 82 respectively overlapping the first active element 60 and the second active element 70 in plan view. The first resistive element 81 is connected in parallel to the first active element 60. The second resistive element 82 is connected in parallel to the second active element 70.

As shown in FIG. 22, the first resistive element 81 overlaps the first active element 60 in plan view. The first resistive element 81 includes the first end 811 and the second end 812. The second end 812 of the first resistive element 81 is electrically connected to the first active element 60. The first end 811 of the first resistive element 81 overlaps the first electrode 41. The first end 811 of the first resistive element 81 is electrically connected to the first electrode 41 by the via 83A.

As shown in FIG. 23, the second resistive element 82 overlaps the second active element 70 in plan view. The second resistive element 82 includes the first end 821 and the second end 822. The second end 822 of the second resistive element 82 is electrically connected to the second active element 70. The first end 821 of the second resistive element 82 overlaps the first electrode 41. The first end 821 of the second resistive element 82 is electrically connected to the first electrode 41 by the via 83B.

As shown in FIG. 24, the first resistive element 81 is formed on the substrate front surface 311 of the semiconductor substrate 31. The first resistive element 81 is adjacent to the semiconductor layer 61a of the first active element 60. The GaInAs layer 62a of the first active element 60 overlaps both the semiconductor layer 61a and the first resistive element 81.

The semiconductor layer 61a and the first resistive element 81 may be formed from the same material. In one example, the semiconductor layer 61a and the first resistive element 81 are formed from GaInAs. The semiconductor layer 61a and the first resistive element 81 may be doped with an n-type impurity at a high concentration. The first resistive element 81 may be formed integrally with the semiconductor layer 61a. In FIG. 24, the broken line indicates the boundary between the semiconductor layer 61a and the first resistive element 81. The broken line does not indicate a boundary that can actually be recognized. Although not shown in the drawings, the second resistive element 82 has the same structure as the first resistive element 81.

The terahertz device 100 in accordance with the second embodiment has the functionality of a detector that detects terahertz waves.

As shown in FIGS. 21 to 23, the first resistive element 81 is electrically connected in parallel to the first active element 60. The second resistive element 82 is electrically connected in parallel to the second active element 70. The first resistive element 81 and the second resistive element 82 of the second embodiment suppress oscillation of the first active element 60 and the second active element 70.

In addition to the advantages of the first embodiment, the first embodiment has the advantages described below.

(2-1) In the same manner as the terahertz device 10 in accordance with the first embodiment, the terahertz device 100 in accordance with the second embodiment includes the first active element 60 and the second active element 70, which are located at opposite sides of the first electrode 41, and allows for impedance adjustment. The terahertz device 100 in accordance with the second embodiment detects terahertz waves with the first active element 60 and the second active element 70. This allows the terahertz device 100 in accordance with the second embodiment to have a high resolution.

(2-2) The terahertz device 100 in accordance with the second embodiment includes the first resistive element 81, which overlaps the first active element 60, and the second resistive element 82, which overlaps the second active element 70. The first resistive element 81 and the second resistive element 82 suppress oscillation of the first active element 60 and the second active element 70. Thus, the terahertz device 100 in accordance with the second embodiment suppresses oscillation of the first active element 60 and the second active element 70.

### Modified Examples

The above embodiments may be modified as described below. The above embodiments and modified examples described below may be combined as long as there is no technical contradiction. In the modified examples described hereafter, same reference characters are given to those components that are the same as the corresponding components of the above embodiments. Such components will not be described in detail.

The reflective layer 33 may be omitted.

The semiconductor substrate 31 may be formed by a stack of substrates.

In this specification, the word “on” includes the meaning of “above” in addition to the meaning of “on” unless otherwise described in the context. Accordingly, the phrase of “first layer formed on second layer” may mean that the first layer is formed directly contacting the second layer in one embodiment and that the first layer is located above the second layer without contacting the second layer in another embodiment. Thus, the word “on” will also allow for a structure in which another layer is arranged between the first layer and the second layer.

The Z-axis direction as referred to in this specification does not necessarily have to be the vertical direction and does not necessarily have to fully coincide with the vertical direction. Accordingly, in the structures disclosed above (e.g., structure shown in FIG. 1), upward and downward in the Z-axis direction as referred to in this specification is not limited to upward and downward in the vertical direction. For example, the X-axis direction may be the vertical direction. Alternatively, the Y-axis direction may be the vertical direction.

The term “annular” as used in the present disclosure may refer to any looped shape, that is, a shape that is endless and continuous. An “annular” shape includes, but is not limited to, a circular shape, an elliptical shape, and a polygonal shape with sharp or rounded corners.

### Clauses

Technical concepts that can be understood from each of the above embodiments and modified examples will now be described. Reference characters used in the described embodiment are added to corresponding elements in the clauses to aid understanding without any intention to impose limitations to these elements. The reference characters are given as examples to aid understanding and not intended to limit elements to the elements denoted by the reference characters.

Clause 1 A terahertz device, including: a substrate (20) including a front surface (21) and a back surface (22); a conductive layer (40) formed on part of the front surface (21); a slot (40A) that is annular and formed in the conductive layer (40); and a first active element (60) and a second active element (70) disposed in the slot (40A) and configured to oscillate or detect electromagnetic waves, where the conductive layer (40) includes a first electrode (41) defined by the slot (40A), and a second electrode (42) surrounding the first electrode (41) with the slot (40A) located in between, the first active element (60) and the second active element (70) are disposed at opposite sides of the first electrode (41) on a straight reference line (LM) that extends through a center of the first electrode (41) as viewed in a plan view taken from a direction orthogonal to the front surface (21), and a first distance (Lx) between opposite ends (P21, P22) of the second electrode (42) on the straight reference line (LM) is less than a first substrate distance (Cx) between opposite ends (P11, P12) of the substrate on the straight reference line (LM).

Clause 2 The terahertz device according to clause 1, where the first distance (Lx) is less than an effective wavelength (λg) of the electromagnetic waves.

Clause 3 The terahertz device according to clause 2, where the first distance (Lx) is less than or equal to one-half of the effective wavelength (λg) of the electromagnetic waves.

Clause 4 The terahertz device according to any one of clauses 1 to 3, where in the plan view, a second distance (Ly) between opposite ends (P23, P24) of the second electrode (42) on a straight auxiliary line (LS) that extends through the center of the first electrode (41) and is orthogonal to the straight reference line (LM) is less than a second substrate distance (Cy) between opposite ends (P13, P14) of the substrate on the straight auxiliary line (LS).

Clause 5 The terahertz device according to clause 4, where the second distance (Ly) is less than an effective wavelength (λg) of the electromagnetic waves.

Clause 6 The terahertz device according to clause 5, where the second distance (Ly) is less than or equal to one-half of the effective wavelength (λg) of the electromagnetic waves. Clause 8 The terahertz device according to any one of clauses 4 to 7, where the slot (40A) is annular and the first electrode (41) is circular in the plan view.

Clause 7 The terahertz device according to any one of clauses 4 to 6, where the second distance (Ly) is less than the first distance (Lx).

Clause 8 The terahertz device according to any one of clauses 4 to 7, where the slot (40A) is annular and the first electrode (41) is circular in the plan view.

Clause 9 The terahertz device according to any one of claims 4 to 8, where the first active element (60) and the second active element (70) are connected in parallel.

Clause 10 The terahertz device according to any one of clauses 4 to 9, further including a first resistive element (81) and a second resistive element (82) electrically connected in parallel to the first active element (60) and the second active element (70).

Clause 11 The terahertz device according to clause 10, where the first resistive element (81) and the second resistive element (82) are arranged in symmetry at opposite sides of the first electrode (41).

Clause 12 The terahertz device according to clause 10 or 11, where the first resistive element (81) and the second resistive element (82) are each electrically connected to the first electrode (41) at an imaginary short-circuit point (45A, 45B).

Clause 13 The terahertz device according to clause 10 or 11, where the first resistive element (81) and the second resistive element (82) are electrically connected to opposite ends of the first electrode (41) on the straight auxiliary line (LS).

Clause 14 The terahertz device according to clause 10 or 11, where in the plan view, the first resistive element (81) overlaps the first active element (60), and the second resistive element (82) overlaps the second active element (70).

Clause 15 The terahertz device according to any one of clauses 4 to 14, further including a reflective layer (33) arranged on the back surface (22) of the substrate (20) and configured to reflect the electromagnetic waves, where the reflective layer (33) overlaps the slot (40A) in the plan view.

Clause 16 The terahertz device according to any one of clauses 4 to 15, further including: a first electrode pad (51) and a second electrode pad (52) arranged on the front surface (21) of the substrate; a first interconnection (53) connecting the first electrode pad (51) and the first electrode (41); and a second interconnection (54) connecting the second electrode pad (52) and the second electrode (42).

Clause 17 The terahertz device according to clause 16, where the first electrode pad (51) and the second electrode pad (52) are each located at an end (a corner) of the substrate.

Clause 18 The terahertz device according to clause 16 or 17, where the first interconnection (53) and the second interconnection (54) are each electrically connected to the first electrode (41) and the second electrode (42) at an imaginary short-circuit point.

Clause 19 The terahertz device according to clause 16 or 18, where the first interconnection (53) and the second interconnection (54) are each electrically connected to an end of the first electrode (41) and an end of the second electrode (42) on the auxiliary straight line (LS).

Clause 20 The terahertz device according to any one of clauses 1 to 19, where the first and second active elements (60, 70) each include any one of a resonant tunneling diode, a tunnel injection transit time (TUNNETT) diode, an Impact Ionization Avalanche Transit Time (IMPATT) diode, a GaAs field effect transistor (FET), a GaN FET, a high electron mobility transistor, a heterojunction bipolar transistor, and a Complementary Metal–Oxide–Semiconductor (CMOS) FET.

Clause 21 The terahertz device according to any one of clauses 1 to 20, where: the substrate (20) is rectangular in the plan view and includes a first side surface (23) and a second side surface (24) facing opposite directions in the plan view; and the straight reference line (LM) is parallel to the first side surface (23) in the plan view.

Clause 22The terahertz device according to any one of clauses 1 to 20, where: the substrate (20) is rectangular in the plan view and includes a first side surface (23) and a second side surface (24) facing opposite directions in the plan view; and the straight reference line (LM) is inclined relative to the first side surface (23) in the plan view.

Clause 23 The terahertz device according to clause 21 or 22, where: the second electrode (42) is rectangular in the plan view and includes a first side (421) and a second side (422) that are parallel to each other; and the straight reference line (LM) is parallel to the first side (421) in the plan view.

Clause 24 The terahertz device according to clause 21 or 22, where: the second electrode (42) is rectangular in the plan view and includes a first side (421) and a second side (422) that are parallel to each other; and the straight reference line (LM) is inclined relative to the first side (421) in the plan view.

Clause 25 The terahertz device according to any one of clauses 1 to 24, where: the second electrode (42) includes a first end (P21) and a second end (P22) on the straight reference line (LM); the first distance (Lx) is a distance between the first end (P21) and the second end (P22); and a distance (LC1) from a center (41C) of the first electrode (41) to the first end (P21) differs from a distance (LC2) from the center (41C) of the first electrode (41) to the second end (P22).

Clause 26 The terahertz device according to any one of clauses 4 to 19, where: the second electrode (42) includes a third end (P23) and a fourth end (P24) on the straight auxiliary line (LS); the second distance (Ly) is a distance between the third end (P23) and the fourth end (P24); and a distance (LC3) from a center (41C) of the first electrode (41) to the third end (P23) differs from a distance (LC4) from the center (41C) of the first electrode (41) to the fourth end (P24).

Clause 27 The terahertz device according to any one of clauses 1 to 20, where the second electrode (42) is elliptical in the plan view.

Clause 28The terahertz device according to any one of clauses 1 to 27, where the first electrode (41) is located at a center of the substrate (20) in the plan view. Exemplary descriptions are given above. In addition to the elements and methods (manufacturing processes) described to illustrate the technology of this disclosure, a person skilled in the art would recognize the potential for a wide variety of combinations and substitutions. All replacements, modifications, and variations within the scope of the claims are intended to be encompassed in the present disclosure.

What is claimed is:

1. A terahertz device, comprising:
a substrate including a front surface and a back surface;
a conductive layer formed on part of the front surface;
a slot that is annular and formed in the conductive layer; and
a first active element and a second active element disposed in the slot and configured to oscillate or detect electromagnetic waves, wherein
the conductive layer includes
a first electrode defined by the slot, and
a second electrode surrounding the first electrode with the slot located in between,
the first active element and the second active element are disposed at opposite sides of the first electrode on a straight reference line that extends through a center of the first electrode as viewed in a plan view taken from a direction orthogonal to the front surface, and
a first distance between opposite ends of the second electrode on the straight reference line is less than a first substrate distance between opposite ends of the substrate on the straight reference line.

2. The terahertz device according to claim 1, wherein the first distance is less than an effective wavelength of the electromagnetic waves.

3. The terahertz device according to claim 2, wherein the first distance is less than or equal to one-half of the effective wavelength of the electromagnetic waves.

4. The terahertz device according to claim 1, wherein in the plan view, a second distance between opposite ends of the second electrode on a straight auxiliary line that extends through the center of the first electrode and is orthogonal to the straight reference line is less than a second substrate distance between opposite ends of the substrate on the straight auxiliary line.

5. The terahertz device according to claim 4, wherein the second distance is less than an effective wavelength of the electromagnetic waves.

6. The terahertz device according to claim 5, wherein the second distance is less than or equal to one-half of the effective wavelength of the electromagnetic waves.

7. The terahertz device according to claim 4, wherein the second distance is less than the first distance.

8. The terahertz device according to claim 4, wherein the slot is annular and the first electrode is circular in the plan view.

9. The terahertz device according to claim 4, wherein the first active element and the second active element are connected in parallel.

10. The terahertz device according to claim 4, further comprising a first resistive element and a second resistive element electrically connected in parallel to the first active element and the second active element.

11. The terahertz device according to claim 10, wherein the first resistive element and the second resistive element are arranged in symmetry at opposite sides of the first electrode.

12. The terahertz device according to claim 10, wherein the first resistive element and the second resistive element are electrically connected to opposite ends of the first electrode on the straight auxiliary line.

13. The terahertz device according to claim 10, wherein in the plan view, the first resistive element overlaps the first active element, and the second resistive element overlaps the second active element.

14. The terahertz device according to claim 4, further comprising a reflective layer arranged on the back surface of the substrate and configured to reflect the electromagnetic waves,
wherein the reflective layer overlaps the slot in the plan view.

15. The terahertz device according to claim 4, further comprising:
a first electrode pad and a second electrode pad arranged on the front surface of the substrate;
a first interconnection connecting the first electrode pad and the first electrode; and
a second interconnection connecting the second electrode pad and the second electrode.

16. The terahertz device according to claim 15, wherein the first electrode pad and the second electrode pad are each located at an end of the substrate.

17. The terahertz device according to claim 15, wherein the first interconnection and the second interconnection are each electrically connected to an end of the first electrode and an end of the second electrode on the auxiliary straight line.

18. The terahertz device according to claim 1, wherein the first and second active elements each include any one of a resonant tunneling diode, a tunnel injection transit time (TUNNETT) diode, an Impact Ionization Avalanche Transit Time (IMPATT) diode, a GaAs field effect transistor (FET), a GaN FET, a high electron mobility transistor, a heterojunction bipolar transistor, and a Complementary Metal–Oxide–Semiconductor (CMOS) FET.
